(19) United States
(12) Patent Application Publication
(10) Pub. No.: US 2017/0334051 A1
(43) Pub. Date: Nov. 23, 2017

(54) DRIVE-IN TOOL WITH LEADTHROUGH INTO COMBUSTION CHAMBER

(71) Applicant: HILTI AKTIENGESELLSCHAFT, Schaan (LI)

(72) Inventors: Norbert HEEB, Buchs (CH); Tilo DITTRICH, Feldkirch (AT); Peter STAUSS-REINER, Feldkirch (AT)

(21) Appl. No.: 15/535,959

(22) PCT Filed: Dec. 16, 2015
(86) PCT No.: PCT/EP2015/079945

§ 371 Date: Jun. 14, 2017

(30) Foreign Application Priority Data
Dec. 19, 2014 (EP) 14199199.2

(51) Int. Cl. B25C 1/08

(52) U.S. Cl. CPC B25C 1/08

(57) ABSTRACT

The invention relates to a drive-in device comprising a drive-in piston which is guided in a cylinder for driving a nail element into a workpiece and comprising a combustion chamber which is arranged over the drive-in piston and which can be filled with a combustion gas. A movable adjusting rod engages through a feedthrough across an axial length (L) in a housing of the combustion chamber, and a guide gap is formed between the adjusting rod and the feedthrough. A recess is formed on at least one of the adjusting rod or the feedthrough, and a radial distance between the adjusting rod and the feedthrough in the region of the recess is greater than a radial height of the guide gap.

The present invention relates to a drive-in tool, in particular, a hand-held drive-in tool, according to the preamble of claim 1.

DE 102 26 878 A1 describes a drive-in tool for driving a nail into a workpiece, with which a combustion chamber is charged with a combustion gas, wherein a drive-in piston is accelerated against the nail after an ignition process. The combustion chamber has an adjustable combustion chamber bottom, wherein an adjusting rod is fed by means of a leadthrough through a housing of the combustion chamber and is connected to the adjustable combustion chamber bottom.

The present invention addresses the problem of setting forth a drive-in tool that enables especially reliable operation even at low ambient temperatures.

This problem is solved, for an aforementioned drive-in tool, according to the present invention with the characterizing features of claim 1. The recess reduces the capillary force for water—in particular, water that has developed during the combustion—in the region of the leadthrough. At the same time, the effective axial length of the guide gap is reduced. As a whole, thus, an amount of water collected in the region of the guide gap is reduced or completely avoided. At temperatures below the freezing point, this makes it possible to keep the adjusting rod movable, or at least reduce a breakaway torque.

A “guide gap” within the meaning of the present invention is understood to mean the smallest distance between the leadthrough and the adjusting rod at a normal ambient temperature. When the leadthrough and the adjusting rod are composed of a hard material, e.g., metal, a defined gap is to be provided in order to prevent the parts from seizing up. Apart from the configuration of the guide gap, the leadthrough may additionally have provided thereon soft elastic seals, e.g., made of rubber or other materials, by which the guide gap is not, however, defined. The radial size of the guide gap is, in the meaning of the present invention, defined at a centered position of the adjusting rod in the leadthrough so that the gap is present running circumferentially around the adjusting rod.

In order to enable favorable and low-clearance guidance of the adjusting rod, the guide gap is usually so small in actual practice that water can be drawn into and held in the gap by capillary action. In practice, a typical size of the guide gap is less than 0.1 mm.

In a preferred embodiment of the present invention, the distance between the adjusting rod and the leadthrough in the region of the recess is at least twice, in particular, at least four times the height of the guide gap. This is preferably understood to be the maximum distance of the recess from the adjusting rod at the corresponding axial position of the adjusting rod. In particular, this axial position of the adjusting rod is preferably a resting position or starting position prior to the initiation of a drive-in operation. An absolute size of the distance is preferably greater than 0.1 mm, preferably greater than 0.3 mm.

In a preferred embodiment of the present invention, at least two, in particular, at least three recesses are provided in succession over the axial length of the leadthrough. There are thereby configured a plurality of sections in which guidance with a small guide gap over a short axial length is achieved, wherein water-free recesses exist between the sections.

In general, it is advantageous to configure a recess at both the adjusting rod and the leadthrough, the recesses being each set back in the radial direction behind a radius associated with the guide gap, i.e., on the inside on the adjusting rod and on the outside on the leadthrough. Especially preferably, then, one of the recesses—preferably the recess on the adjusting rod—is configured as a continuous taper over the axial length thereof. This prevents, as a whole, water from collecting, at least encompassing a starting position of the adjusting rod, and nevertheless also ensures sufficient guidance. The axial extension of the recess over the adjusting rod is then preferably shorter than, substantially equally as long as, or only slightly longer than—in particular, not more than twice as long as—the axial length of the leadthrough.

In the interest of favorable guidance, a bevel may be configured on one end of the recess. Such a bevel or chamfer prevents opposite recesses from catching at the edges thereof.

In an especially preferred embodiment of the present invention, a swirler plate is fastened to the adjusting rod within the combustion chamber. Such a swirler plate is moved by means of the adjusting rod through the combustion chamber shortly before ignition of the combustion chamber in order to bring about better mixing of combustion gas and air.

In an alternative or complementary embodiment, an adjustable bottom of the combustion chamber is fastened to the adjusting rod. Such a bottom makes it possible to collapse the combustion chamber, for example, as part of a safety device if the tool has not been properly placed on a workpiece.

In an alternative or complementary embodiment, an adjustable combustion chamber wall is fastened to the adjusting rod. Preferably, the combustion chamber wall is configured as a sheath. With the aid of such a combustion chamber wall, the combustion chamber can be opened and closed again, for example, in order to spray the combustion chamber with fresh air.

Other advantages and features of the present invention shall be apparent from the following description of embodiments and from the dependent claims.

A plurality of embodiments of the present invention shall be described hereinbelow and set forth in greater detail with reference to the accompanying drawings.

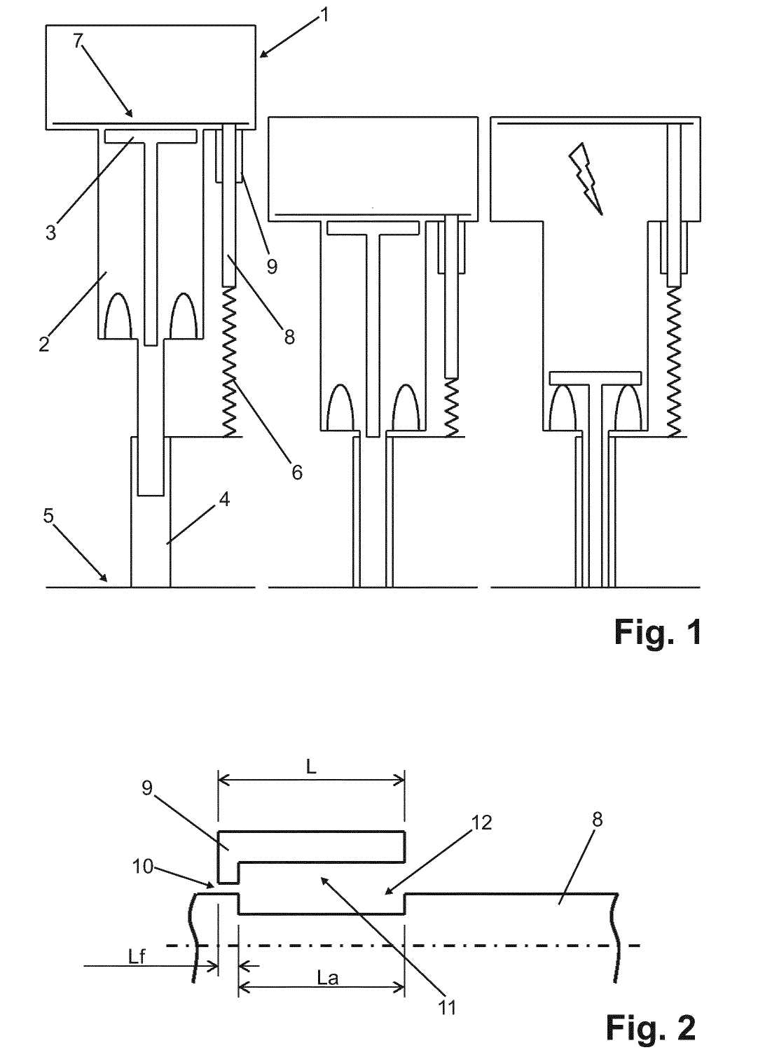

FIG. 1 illustrates a schematic view of a drive-in tool according to the present invention, in three different operating states;

FIG. 2 illustrates a sectional view of a leadthrough according to a first embodiment of the present invention; and

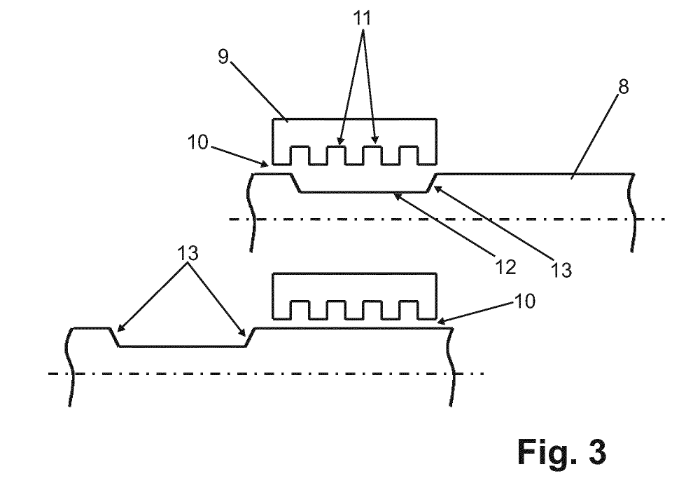

FIG. 3 illustrates a leadthrough according to a second embodiment of the present invention.

The drive-in tool from FIG. 1 comprises a hand-held tool comprising a housing 1 of a combustion chamber, and a cylinder 2 that is adjacent to the combustion chamber 1 and has a drive-in piston 3 guided therein. A safety mechanism of the tool comprises an attachment sheath 4 that is placed on a workpiece 5 and is pressed against the pressure of a spring 6. Only in this state can a drive-in operation be triggered by ignition of a combustion gas in the combustion chamber.

A swirler plate 7 that is fixedly connected to an adjusting rod 8 is additionally arranged in the combustion chamber 1. The adjusting rod 8 penetrates through the wall of the combustion chamber housing 1 via a leadthrough 9 arranged in the wall. In this manner, the swirler plate 7 can be moved from the outside via the adjusting rod 8 into the combustion chamber 1. Presently, the adjusting rod 8 is schematically connected to the spring 6. The pressing of the attachment sheath 4 first tensions the spring 6, wherein the adjusting rod 8 is retained via a mechanism that is not shown.

When a drive-in operation is triggered, first the adjusting rod 8 is released so that an expansion of the spring 6 moves the swirler plate 7 through the combustion chamber 1. This causes combustion gas and air to be better mixed. The ignition (right view in FIG. 1) takes place immediately after or even during the movement of the swirler plate.

At temperatures below the freezing point, there is the possibility that the adjusting rod 8 could become stuck due to ice formation in a guide gap 10 in the leadthrough 9, and have too great a breakaway torque. FIG. 1 depicts the leadthrough 9 and adjusting rod 8 schematically and in a conventional manner.

In the embodiment of the present invention according to FIG. 2, the leadthrough 9 has an axial length L. The guide gap 10 has a significantly smaller axial length Lf. The rest of the length L of the leadthrough 9 has a recess 11 protruding radially outward. The recess 11 has an axial length La. In this example, L=Lf+La. In addition, the adjusting rod 8 has a radially inwardly-tapered recess 12 having an axial length that also approximately corresponds to La. The position of the adjusting rod 8 in FIG. 2 corresponds to a starting position or resting position, as in the left drawing in FIG. 1 (starting position; the swirler plate is located on a front stop).

In this position, the recesses 11, 12 cover in the region of the leadthrough, so that here there is a greater radial distance between the surfaces of the adjusting rod 8 and the leadthrough 9. The distance is much larger than the guide gap and prevents any water from being able to spread through capillary action over the length of the recesses La. In the event that water droplets are located in the region of the surfaces in the recesses 11, 12, then freezing thereof does not lead to blockage of the adjusting rod 8.

In the second embodiment according to FIG. 3, the guidance of the adjusting rod 8 is improved by the successive arrangement of a plurality of—accordingly, shorter—recesses 11 in the axial direction at the leadthrough 9. Overall, through recesses 11 are present, which protrude radially outward and between each of which a web-like projection projects inward to the radius of the guide gap. In the cross-section, this results in a comb-like structure of the leadthrough 9. The overall axial length of the leadthrough 9 is unchanged relative to the first embodiment.

The recess 12, protruding radially inward, on the side of the adjusting rod 8 has bevels or chamfers 13 at the end thereof, unlike in the first embodiment. This prevents the recess 12 from snagging or cogging with the ends of the leadthrough 9.

The upper image in FIG. 3 illustrates the adjusting rod in the starting position thereof, in which freezing due to deposited water is effectively prevented or reduced in the surface thereof.

In the starting position according to FIG. 3, the adjusting rod of the second embodiment has a slightly increased radial clearance in the leadthrough. It is, however, negligible at the start of the accelerated movement of the swirler plate.

In the lower image, the adjusting rod has been displaced a way to the left, so that the recesses 11, 12 no longer cover the adjusting rod 8 and the leadthrough 9. A state of optimal guidance has then been achieved, and the radial clearance is limited by the guide gap. In such a position, the combustion gas is also ignited such that favorable sealing against the gas pressure is ensured.

It shall be understood that the individual features of the two embodiments may be combined with one another as appropriate, depending on the requirements.

1. A drive-in tool, comprising
a drive-in piston which is guided in a cylinder for driving a nail member into a workpiece; and
a combustion chamber which is arranged over the drive-in piston and which can be filled with a combustion gas, the combustion chamber comprising a housing;
wherein a movable adjusting rod having an axial length (L) engages through a leadthrough across the axial length (L) in the housing;
wherein a guide gap is formed between the adjusting rod and the leadthrough, the guide gap having a radial height; and wherein
a recess is formed on at least one of the adjusting rod and the leadthrough, wherein a radial distance between the adjusting rod and the leadthrough in a region of the recess is greater than the radial height of the guide gap.

2. The drive-in tool according to claim 1, wherein the radial distance between the adjusting rod and the leadthrough in the region of the recess is at least two times the radial height of the guide gap.

3. The drive-in tool according to claim 1, wherein at least two recesses are provided in succession over the axial length (L) of the leadthrough.

4. The drive-in tool according to claim 1, further comprising an additional recess, one recess being formed on the adjusting rod and the additional recess being formed on the leadthrough, each recess being set back in the radial direction behind a radius associated with the guide gap.

5. The drive-in tool according to claim 4, wherein one of the recesses has an axial length (La), and is configured as a continuous taper over the axial length (La) thereof.

6. The drive-in tool according to claim 1, wherein a bevel is configured at an end of the recess.

7. The drive-in tool according to claim 1, further comprising a swirler plate fastened to the adjusting rod within the combustion chamber.

8. The drive-in tool according to claim 1, wherein the combustion chamber has an adjustable bottom that is fastened to the adjusting rod.

9. The drive-in tool according to claim 1, wherein the combustion chamber has an adjustable combustion chamber wall that is fastened to the adjusting rod.

10. The drive-in tool according to claim 9, wherein the combustion chamber wall is configured as a sheath.

11. The drive-in tool according to claim 2, wherein the radial distance between the adjusting rod and the leadthrough in the region of the recess is at least four times the radial height of the guide gap.

12. The drive-in tool according to claim 5, wherein the recess on the adjusting rod is configured as a continuous taper over the axial length (La) thereof.

13. The drive-in tool according to claim 2, wherein at least two recesses are provided in succession over the axial length (L) of the leadthrough.

14. The drive-in tool according to claim 2, further comprising an additional recess, one recess being formed on the adjusting rod and the additional recess being formed on the leadthrough, each recess being set back in the radial direction behind a radius associated with the guide gap.

15. The drive-in tool according to claim 3, further comprising an additional recess, one recess being formed on the adjusting rod and the additional recess being formed on the leadthrough, each recess being set back in the radial direction behind a radius associated with the guide gap.

16. The drive-in tool according to claim 14, wherein one of the recesses has an axial length (La), and is configured as a continuous taper over the axial length (La) thereof.

17. The drive-in tool according to claim 15, wherein one of the recesses has an axial length (La), and is configured as a continuous taper over the axial length (La) thereof.

18. The drive-in tool according to claim 2, wherein a bevel is configured at an end of the recess.

19. The drive-in tool according to claim 3, wherein a bevel is configured at an end of the recess.

20. The drive-in tool according to claim 4, wherein a bevel is configured at an end of the recess.
